(19) United States
(12) Patent Application Publication
(10) Pub. No.: US 2003/0028530 A1
(43) Pub. Date: Feb. 6, 2003

(54) Method and apparatus for accelerating search functions

(76) Inventor: Srikanth Nagaraja, Bangalore (IN)

Correspondence Address: HOFFMANN & BARON, LLP, 6900 JERICHO TURNPIKE, SYOSSET, NY, 11791, US

(21) Appl. No.: 09/923,262

(22) Filed: Aug. 6, 2001

(51) Int. Cl. G06F 7/00

(52) U.S. Cl. 707/4

(57) ABSTRACT

A system includes a microprocessor and an integrated circuit, which has interface, logic, and storage circuits for accelerating database search functions. The storage circuit includes table memory and operational plane memory, each location of which may be simultaneously coupled in parallel to a unique location in table memory. A method includes the steps of inputting unsorted entries and performing a first hash function, which sorts the entries into tables. The method also includes storing the sorted tables in table memory, inputting a search key, and performing a second hash function on the search key. The second hash function outputs a table identifier representing the table in which the search key will likely be found. The method further includes simultaneously transferring the table represented by the table identifier in parallel from table memory to operational plane memory and performing a search function on that table using the search key.

### BACKGROUND OF THE INVENTION

1. Field of the Invention

The present invention generally relates to integrated circuits and more particularly to a method, system, and peripheral device for microprocessors that accelerates the performance of database search functions.

2. Description of the Prior Art

Determining whether a given number is in a list of numbers is a process that is often performed by microprocessors and microcontrollers. The given number is commonly called a “search key” and the processor searches the list and reports either a success or failure.

More commonly, the list or table of numbers is sorted, for instance, in increasing order and each entry in the table is assigned an index. After completing the search using the given search key, the processor typically returns the index of the largest entry that is smaller than the search key.

Traditionally such searches have been executed by a central processing unit, which is typically a general-purpose microprocessor, in a sequential manner. The conventional so-called “sequential binary search” is summarized in the flowchart of FIG. 1.

Entries in a table are first sorted in increasing order in step 10, and the middlemost entry in the table is selected in step 12. The selected entry is then compared to the search key in step 14, and if the selected entry is equal to the search key in step 16, the algorithm outputs the index of the selected entry as a result of the search in step 18 and then ends. If the selected entry is greater than the search key in step 20, the upper half of the table is discarded in step 22 and the algorithm returns to step 12 to select the middlemost entry of the remaining table. However, if the selected entry is not greater than the search key in step 20, the lower half of the table is discarded in step 24 and the algorithm returns to step 12 to select the middlemost entry of the remaining table.

For instance, given a table having 7 entries between 1 and 10 that are sorted in increasing order and a search key equal to 3, the algorithm would first select the middlemost entry in the table, which is the fourth entry from the left or the right. If the selected entry were less than 3, the algorithm would discard the lower half of the table. However, if the selected entry were greater than 3, the algorithm would discard the upper half of the table. The algorithm would then repeat this process for the remaining portion of the table.

Performance of the sequential binary search discussed above is substantially improved by using N parallel processors operating on a table having N entries. Such a search is commonly called a “parallel N-ary search” and is summarized in the flowchart of FIG. 2.

The entries in the table are again sorted in increasing order in step 26, and each entry in the table is assigned one of N parallel processors in step 28. Each of the N parallel processors then compares its assigned entry to a search key in step 30. If the assigned entry is less than or equal to the search key in step 32, that particular processor outputs a “0” in step 34. If the assigned entry is not less than or equal to the search key, that particular processor outputs a “1” in step 36.

Each of the N parallel processors that have outputted a “0” in step 34 then read the output of their successor processor, that is, the processor assigned the entry having the next higher index in the table, in step 38. If the successor processor has output a “1” in step 40, that processor outputs the index of its assigned entry in step 42 and the algorithm ends. There is at most one such processor for which this condition occurs. Therefore, a unique index is generated. Thus, the algorithm provides the index of that entry in the table that is less than or equal to the search key.

It is possible to build an N-ary search system where N is in thousands, economically. The table sizes are typically in millions. The sequential solution takes log₂10⁶=20 units of time. It may be hoped that by using a 1000-ary search, the time taken will be reduced to log₁₀₀₀10⁶=2 units of time. However, this is not the case, since after each search, the memory on which the 1000-ary search operated must be updated by the sequential computer. The sequential computer takes 1000 instructs to do so, thereby taking 2002 units of time to perform the complete operation. In summary, in the prior art, there is an insurmountable problem of reducing the time taken by an N-ary search by a factor of log N.

### OBJECTS AND SUMMARY OF THE INVENTION

It is an object of the present invention to provide a method and apparatus for reducing the time taken by an N-ary search by a factor of log N.

It is another object of the present invention to provide a method and apparatus for efficiently performing various database search algorithms on multi-dimensional arrays of memory in a cost-effective manner.

It is still another object of the present invention to provide an integrated circuit having logic functions and storage capability that are peripheral to a microprocessor wherein the integrated circuit performs repetitive functions on multi-dimensional arrays of memory that are stored within the integrated circuit.

It is a further object of the present invention to provide an integrated circuit having multiple processors therein and concurrent read and concurrent write capability for accelerating database search functions peripheral to a general-purpose microprocessor.

It is still a further object of the present invention to provide a method and apparatus for upgrading the performance of existing microprocessor- or microcontroller-based systems.

It is yet another object of the present invention to provide an integrated circuit for accelerating operations performed in floating point arithmetic processors, translation-look-aside buffers, routers, switches, graphic processors, compilers, word processing algorithms, and Internet security algorithms.

An integrated circuit formed in accordance with one form of the present invention, which incorporates some of the preferred features, includes an interface circuit, a logic circuit, and a storage circuit. The interface circuit provides an electrical interface between the logic circuit, the storage circuit, and a device external to the integrated circuit, such as a microprocessor.

The logic circuit performs a search function on entries in a table given a search key. The search key represents the number being searched for in the table. The storage circuit preferably includes table memory and operational plane memory.

The operational plane memory is preferably coupled to the table memory such that each location in operational plane memory can simultaneously be coupled in parallel to a unique location in table memory. This enables entries to be simultaneously or concurrently transferred between table memory and operational plane memory in one instruction cycle or unit time.

A method formed in accordance with one form of the present invention, which incorporates some of the preferred features, includes the steps of storing a plurality of tables into table memory in an integrated circuit, and inputting a table identifier and a search key. The table identifier represents one of the tables. The method also includes simultaneously transferring one of the tables, which is represented by the table identifier, in parallel from table memory to operational plane memory, and performing a search function on this table using the search key. The results of the search function are then outputted.

A system formed in accordance with one form of the present invention, which incorporates some of the preferred features, includes the integrated circuit discussed above and at least one device external to the integrated circuit, such as a microprocessor.

A method formed in accordance with another form of the present invention, which incorporates some of the preferred features, includes the steps of inputting unsorted entries, and performing a first hash function on the unsorted entries. The first hash function arranges the unsorted entries into a plurality of unsorted tables.

The method also includes storing the plurality of sorted tables into table memory in an integrated circuit, inputting a search key, and performing a second hash function on the search key. The second hash function outputs a table identifier, which represents one of the plurality of sorted tables in which the search key is likely to be found.

The method further includes simultaneously transferring one of the tables, which is represented by the table identifier, in parallel from table memory to operational plane memory, and performing a search function on that table using the search key. The results of the search function are then outputted.

These and other objects, features, and advantages of this invention will become apparent from the following detailed description of illustrative embodiments thereof, which is to be read in connection with the accompanying drawing.

### BRIEF DESCRIPTION OF THE DRAWING

FIG. 1 is a flowchart of a conventional, sequential binary search algorithm;

FIG. 2 is a flowchart of a conventional, parallel N-ary search algorithm;

FIG. 3 is block diagram of a system that performs a search function formed in accordance with the present invention;

FIG. 4 is a block diagram of a storage circuit shown in FIG. 1;

FIG. 5 is a block diagram showing one embodiment of the organization of table memory or operational plane memory shown in FIG. 2; and

FIG. 6 is a relational flowchart showing a method for performing a search function in accordance with the present invention.

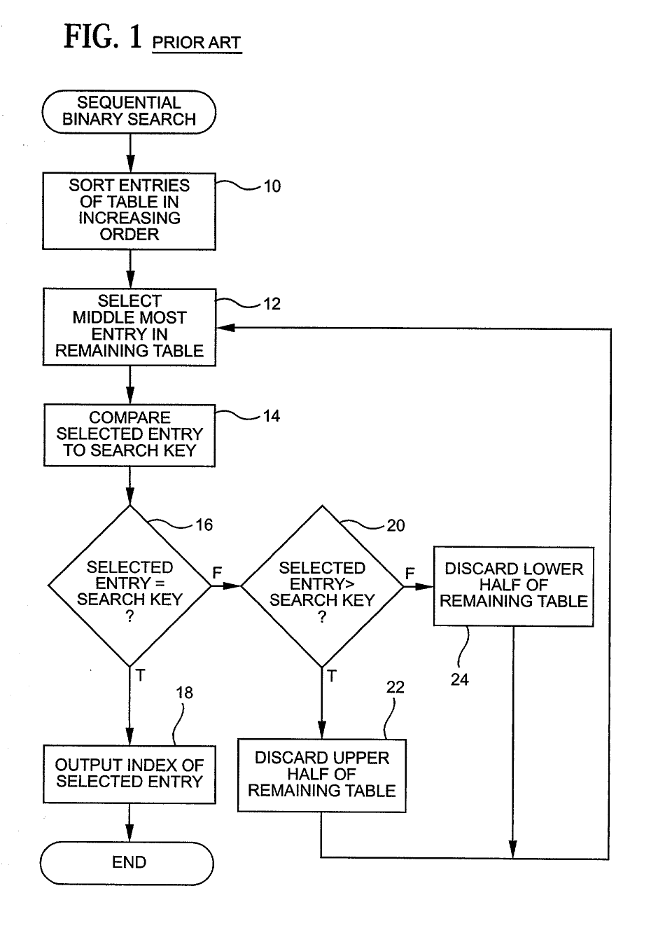

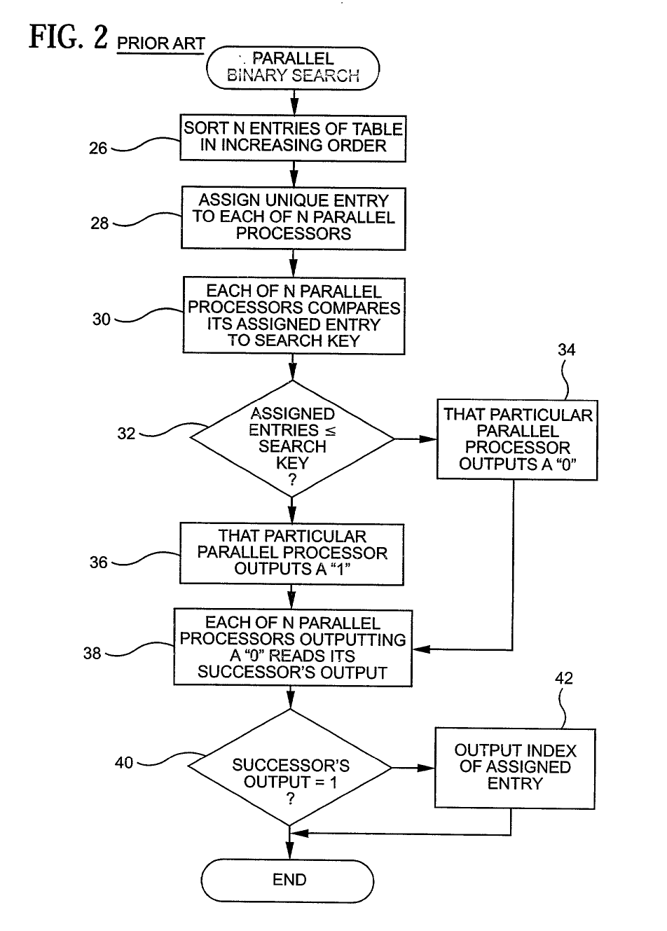

### DETAILED DESCRIPTION OF THE PREFERRED EMBODIMENTS

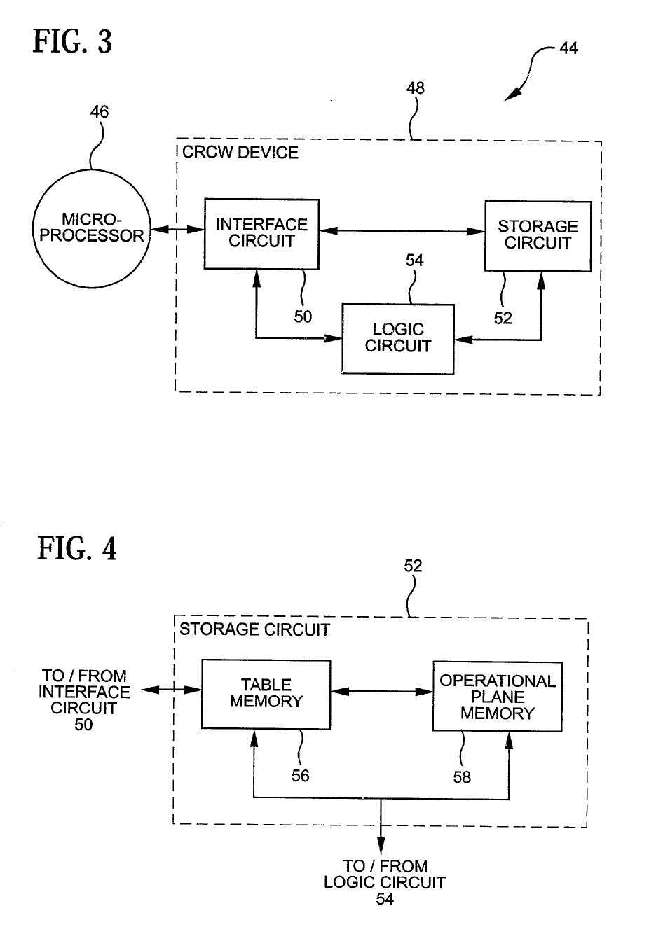

A system 44 for performing database search functions is shown in FIG. 3. The system 44 includes an integrated circuit or CRCW (concurrent read-concurrent write) device 48 and a microprocessor 46, microcontroller, or application specific integrated circuit (ASIC), which is external to the CRCW device 48.

The CRCW device 48 includes an interface circuit 50, a storage circuit 52, a logic circuit 54, and preferably operates as a peripheral to the microprocessor 46. The microprocessor 46 communicates with the CRCW device 48 in the same manner as it would with any other peripheral device, such as a sound card. Preferably, a device driver program is written that is executed by the microprocessor 46 to communicate with the CRCW device 48.

The storage circuit 52 preferably stores tables on which a search function is performed, and the logic circuit 54 preferably includes software and hardware circuitry for performing the search function. The interface circuit 50 coordinates communication between the logic circuit 54, storage circuit 52, and the microprocessor 46. The logic circuit 54 preferably includes a plurality of processors configured to perform the search function in parallel on entries of the table stored in the storage circuit 52.

The interface circuit 50 preferably includes registers that may be read from or written by the microprocessor 46. The microprocessor 46 preferably writes commands into these registers and reads the results of the search function from them. The remainder of the interface circuit 50 interprets the commands written by the microprocessor 46 and initiates functions in the CRCW device 48 in response to these commands.

The interface circuit 50 preferably loads tables from the microprocessor 46 to the storage circuit 52, stores an identifier representing the particular table on which the search function is to be performed, stores a search key, stores the type of search to be performed, and provides the results of the completed search function to the microprocessor 46. For instance, a first command written to the interface circuit 50 by the microprocessor 46 would preferably select that portion of the storage circuit 52 in which to store one or more tables. A second command would preferably select the table previously stored in the storage circuit 52 for searching, and a third command would preferably initiate the search. The interface circuit 50 preferably includes at least three internal registers—one each to identify the table being searched, the search key, and the type of search function being performed.

The logic circuit 54 preferably includes N parallel processors that search N entries of a table stored in the storage circuit 52. Two search functions are preferably implemented depending upon the expected result. For instance, if an exact match of the search key is required, the logic circuit 54 preferably performs an equality comparison between the search key and each of the entries in the table. However, if the N entries are pre-sorted, the user may require that the CRCW device 48 output two entries between which the search key is located.

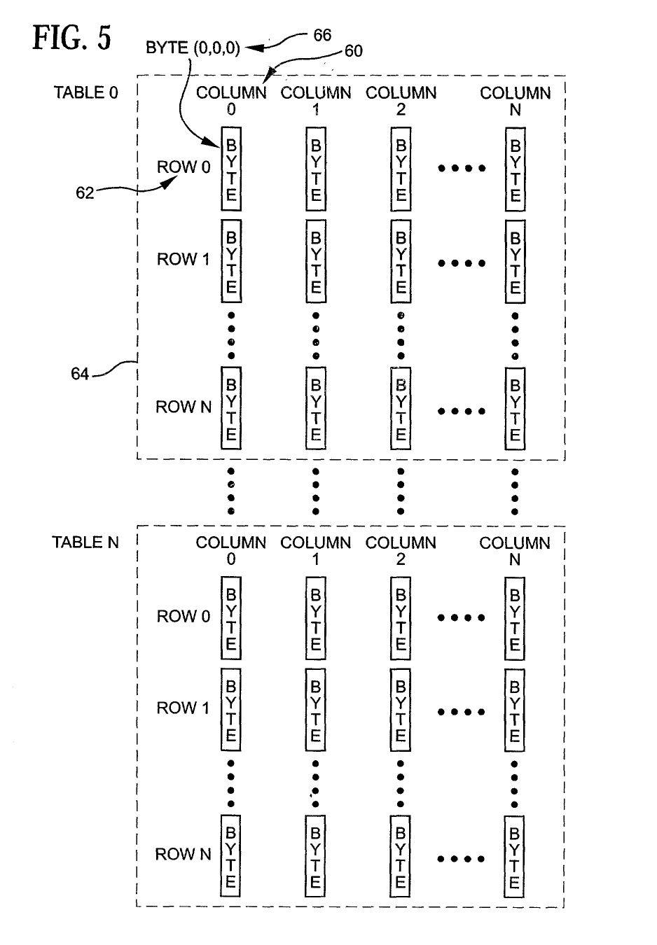

As shown in FIG. 5, table memory 56 and operational plane memory 58 in the storage circuit 52 are preferably organized as three-dimensional arrays of memory. The three dimensions are preferably columns 60, rows 62, and tables 64. Each column 60 is preferably an array of bytes, and each row 62 is preferably an array of columns 60. Each table 64 is then preferably an array of rows 62. The storage circuit 52 may also be visualized as a stack of work sheets, such as those used in spreadsheet applications. In order to access a particular cell or byte 66 in either the table memory 56 or the operational plane memory 58, the table 64, the row 62 in that table 64, and the column 60 in that row 62 is preferably specified using the notation “byte (C,R,T)”, where “C” represents the column number, “R” represents the row number, and “T” represents the table number.

As shown in FIG. 4, the storage circuit 52 preferably includes table memory 56 and operational plane memory 58, which are both preferably accessible from the logic circuit 54. Table memory 56 preferably stores each of the tables to be searched and operational plane memory 58 preferably stores the particular table currently being searched.

Table memory 56 and operational plane memory 58 are preferably coupled by M parallel data lines where M is equal to the number of bits in operational plane memory 58 or the number of bits in one table. This enables each of the entries in one table of table memory 56 to be copied to operational plane memory 58 in one instruction cycle or unit time.

Unit time is defined as one clock cycle of the microprocessor 46 and the CRCW device 48 uses the microprocessor clock cycle as its system clock. When the system clock pulse rises, a particular table in table memory 56 is preferably selected, and when the system clock pulse falls, the table selected in table memory 56 is preferably concurrently or simultaneously copied to operational plane memory 58.

For instance, if there are 100 bits in each table and there are 10 such tables, operational plane memory 58 would preferably include 100 bits of memory and there would be 100 dedicated, parallel data lines running between table memory 56 and operational plane memory 58. If table 3 were selected, then only the bits in table 3 would be transferred on a corresponding parallel data line to operational plane memory 58. The bits in the remaining unselected tables in table memory 56 would not be transferred.

Thus, contention between simultaneous devices driving the same data line and the resulting damage to such devices may be avoided during concurrent read and concurrent write operations. Similarly, the content of operational plane memory 58 may be restored to the appropriate area in table memory 56 by reversing the process described above during a concurrent read process, which also preferably occurs in unit time.

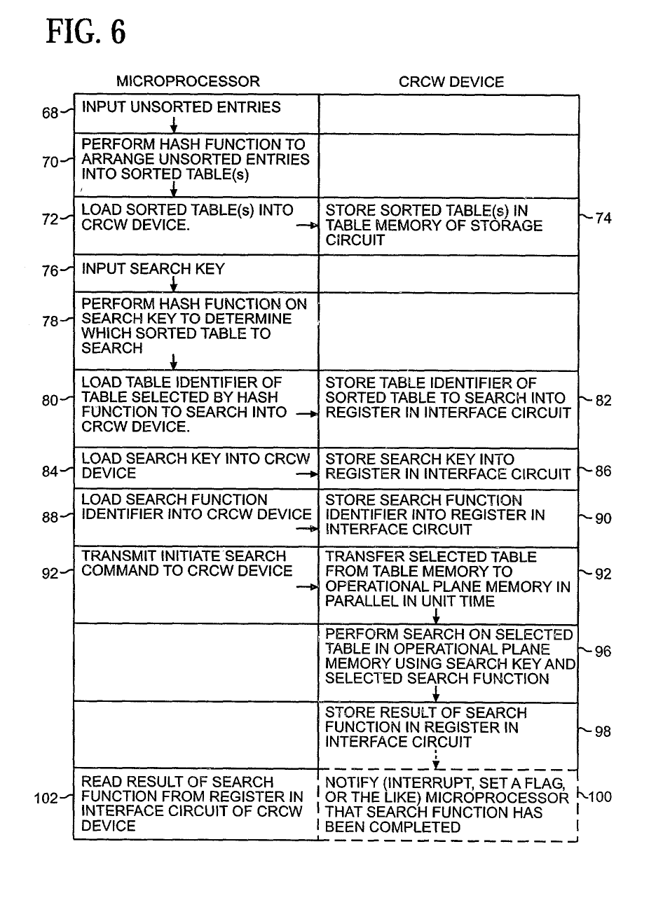

FIG. 6 is a relational flowchart showing the operation of the system for performing a search function shown in FIG. 3. The microprocessor preferably inputs unsorted entries in step 68 and performs a first hash function to arrange the unsorted entries into one of more sorted tables in step 70. The microprocessor then preferably loads the sorted tables into the CRCW device in step 72 and the CRCW device stores the sorted tables in table memory in the storage circuit in step 74.

The microprocessor then preferably inputs a search key in step 76 and performs a second hash function in step 78 (which may be the same or different than the first hash function) on the search key to determine which sorted table is associated with the search key, and therefore in which table to search for the search key. The microprocessor then preferably loads a table identifier, which represents the table selected by the second hash function into the CRCW device in step 80 and the CRCW device stores the table identifier in a register in the interface circuit in step 82.

The microprocessor preferably loads a search key into the CRCW device in step 84 and the CRCW device stores the search key in a register in the interface circuit in step 86. The microprocessor then preferably loads a search function identifier into the CRCW device, which identifies a particular search function to perform if a plurality of search functions are possible, in step 88 and the CRCW device stores the search function identifier in a register in the interface circuit in step 90. The search function is preferably initiated in response to transmission of an initiate search command from the microprocessor in step 92, which also causes the CRCW device to transfer the selected table from table memory to operational plane memory in step 92.

The CRCW device then preferably performs the selected search function on the selected table in operational plane memory using the given search key in step 96. Once completed, the CRCW device preferably stores the results of the search function in a register in the interface circuit in step 98. The microprocessor may optionally be notified by the CRCW device, such as by an interrupt, setting a flag, and the like, that the search function has been completed in step 100 and then preferably reads the results of the search in step 102.

Steps 68 through 74 are typically performed only once daily by the microprocessor. However, the remaining steps, that is, steps 76 through 102 may be performed as much as a million times per second, which would not have been possible without the CRCW device.

Although the discussion above relates to database management, this is intended to be exemplary and not to limit the subject invention, which has extensive applicability in the areas of floating point arithmetic operations, routers, Internet security processes, compilers, word processing routines, and translation-look-side buffers. Substantial improvements in performance in each of these areas benefit the corresponding software and computer vendor, chip manufacturer, and the end user. The following provides an overview of the performance gains that may be achieved in some of the areas listed above including database management

Database Management

In order to efficiently deal with large amounts of data, a database engine organizes its data in tables and preferably stores the data in a sorted order. The engine builds indices on the tables and looks them up each time a database transaction is required.

Large databases have peculiar problems and various time consuming solutions to overcome them. However, the main problem remains scalability, that is, whether the database engine can handle the required number of transactions per hour.

In order to analyze this issue, a transaction is broken into a number of subtasks and each of these subtasks is carried out in a pipelined fashion. Thus, the core of the database engine may be modeled as follows:

1. fetch the next transaction;

2. perform a search on the index;

3. retrieve the record corresponding to the index;

4. modify and/or update the record;

5. return to step one.

These steps may be executed a million times per second or more. Thus, decreasing the time required for their execution provides a significant benefit. The allocation of time requirements for the algorithm listed above will now be provided.

To fetch the next transaction, an address pointer is incremented to the next element in a list of transactions. This can be performed by an increment operation on an address available in a register, which preferably takes three instruction cycles. For analysis purposes, a binary search algorithm is used for step 2 above, the assembly language for which is preferably as follows:

i. MOV B,UPPER;

ii. MOV C,LOWER;

iii. MOV D,KEY;

iv. ADD B,C;

v. RIGHT SHIFT E;

vi. MOVM F,E;

vii. COMPARE D,F;

viii. JUMP EQUAL 14;

ix. JUMP GREATER THAN 12;

x. MOV C,E;

xi. JUMP 4;

xii. MOV E,C;

xiii. JUMP 4;

xiv. RTN.

Steps iv through xiii are executed log₂N times where N is the number of entries in the table. Then, either steps x and xi are executed or steps xii and xiii are executed. Each iteration of the algorithm takes about 50 instruction cycles. Therefore, if there are a million entries in a table, the time required to complete the search would be about log₂10⁶·50=20·50=1000 instruction cycles.

Regarding step 3 of the database engine, data needs to be fetched from a particular location, which is conventionally stored contiguously on a hard disk. The driver for the disk needs to be configured to copy X number of bytes starting from a specified address into main memory, which may be performed in about 10 machine cycles.

Step 4 of the database engine is executed much less frequently and can be substantially ignored during the lifetime of the database engine. However, during the initial stages, step 4 is commonly executed. During this step, modified data is available and all that needs to be done is to write the data back to the hard disk, which takes about 10 instruction cycles.

Step 5 of the database engine is a jump instruction, which takes about 9 instruction cycles. Thus, steps 1, 3, 4, and 5 take about 3+10+10+9=32 machine cycles, whereas step 2 alone takes about 1000 machine cycles. Therefore, the total time required by the database engine is about 1032 machine cycles.

If step 2 is performed by the CRCW device, which requires about 10 instruction cycles, the total time is reduced to about 42 machine cycles. This provides an improvement by a factor of 20-30 times, which generates substantial hardware savings for the end user and provides a competitive edge to the database developer through superior performance.

Floating Point Arithmetic Operations

General-purpose microprocessors typically use very basic mathematical and logical operations. Any complicated math operation is written in terms of these simple operations. However, this approach is not ideal for math-intensive algorithms.

Math coprocessors have been used to solve such problems. These devices have complicated math instructions as part of an instruction set and implement these instructions in hardware, thereby achieving a significant improvement in performance.

While floating-point accelerators can efficiently execute complex multiplication and division on floating point numbers, computers continue to rely on pre-computed tables of logarithms, sines and cosines. For each such function, a corresponding table must be loaded into main memory.

Generally, for every function in math, there exists an inverse function. Traditional approaches treat both as a separate function and compute different tables for each. The CRCW device performs an inverse computation as efficiently as its complementary computation while reducing the number of tables required in memory by a factor of two. Moreover, since the CRCW device stores tables in on-board memory, the impact on main memory is insignificant.

These savings become critical in a time-sharing, client-server environment where the server is shared by hundreds of clients and different clients are working on different applications at different times. If half the clients are running math-intensive algorithms and the other half are running programs not involving math functions, such compilers, the pages being accessed by the latter compete with pre-computed math tables for main memory.

This results in some pages of the table being paged out. When these pages are accessed, a page fault is generated and the computation suffers. This situation is obviated by use of dedicated memory for these tables within the CRCW device. While a first order savings in memory space is achieved due to storing only half the tables required by conventional approaches, a significant second order savings is achieved due to a reduction in page faults. Thus, math-intensive software gains a competitive advantage through superior performance and the end user experiences a reduction in the cost and requirements of main memory as well as an obvious improvement in throughput.

Routers

Routers are used to route IP (Internet protocol) packets appropriately. These devices transmit data over a data link layer and ensure that all the packets are sent over a single medium or wire between two points in a substantially error-free manner.

The network consists of a large number of nodes connected to each other, and thus one of the problems associated with vast networks is naming each node uniquely. Giving each node a unique IP address solves this problem. Another problem with such networks is how to determine the path for data from its source to a destination.

All nodes are not connected to each other through a separate wire. Most nodes are connected to just one or two nodes in the network and the network is realized by a distributed algorithm wherein each node becomes a router having its own routing table. Each node knows the IP address of those nodes to which it is directly connected. It also knows that when a request is received and it must send a packet to these IP addresses, it must send this packet to its neighbors over the data link layer. The routing table consists of information that enables the router to decide to which of its neighbor it should forward the IP packet and which packets it should accept as its own.

The topology of the network is dynamic. New nodes are created while existing nodes go offline. Thus, the routing table is updated dynamically and periodically. Routing tables attempt to capture the shortest possible path between any two nodes. Other features are built into the IP layer to avoid loops in a packet and to selectively provide special services.

Thus, routers perform three types of tasks to achieve routing. First, they must periodically and dynamically update their routing tables with the latest routing information, which is done at least once a day. Second, they must send and receive data (the payload) on the network. Third, they must determine whether to send packets that they have just received. This involves consulting the routing table, which is performed once for each incoming packet, and thus requires a substantial amount of time.

The size of IP packets is less than 1500 bytes, which implies that the processor takes an average of about 750 cycles to read the packet and another 750 cycles to send the packet. If the binary search algorithm is used, the processor needs about 500 cycles to perform routing alone. However, the CRCW device accomplishes this search in about 10 cycles, which means that the capacity of the router is increased by about 33%. While the superior performance of a router with the CRCW chip provides a competitive edge to software vendors, end users also benefit from access to a network with improved bandwidth utilization and far less congestion.

Internet Security Applications

Security over the Internet is typically achieved through SSL (secure sockets layer) and public key encryption. Encryption ensures that only the intended person reads an e-mail transmission and SSL ensures that the data is transferred between two points securely.

Security is often used with corporate e-mail, for which the trend is towards a centralized e-mail server rather than a distributed e-mail system. This means that despite having offices in Bangalore, San Jose and London, there will be only one e-mail server. Clients will log onto this server from different places and read their e-mail.

Some encryption algorithms require both a public key and a private key. The client currently stores these keys. If a user moves from one location to another, he must transport his keys on a floppy disk and reinstall them at different sites. Then, when the client returns to his original location, he must ensure that the keys are erased from temporary storage at the remote sites.

This, however, would not have been the case, if the security features were made a server utility and the data were transferred between the client and the server via SSL in a secure fashion. Security is still provided and, at the same time, the user is given greater mobility, which is the principle behind a so-called “wallet concept”.

If security becomes a server feature, then the server must store the public and private keys of all users and the public keys of their contacts. The server also preferably encrypts e-mail using the public keys of the user's contacts, and decrypts e-mail with the user's private keys.

Encryption may be performed in two steps. In the first step, a common key encryption is used. In the second step, the common key is encrypted using the public key of the recipient. Public key encryption is far more expensive than common key encryption, which is the primary reason for not encrypting the complete text of a message.

The CRCW device preferably encrypts and decrypts a common key with a particular user's public or private key. There is preferably one table for each user and each row in the table preferably contains the public key of a particular contact. The encryption and decryption algorithm are preferably implemented in hardware within the logic circuit of the CRCW device.

This architecture essentially eliminates the need for fetching keys as well as the need for execution of public key encryption/decryption algorithms by the main processor. Even if a chip able to perform single key encryption/decryption algorithms is developed, the CRCW chip would still be able to cooperate with such a chip to achieve greater security while improving throughput by removing security overhead in the central processor.

For instance, if a thousand users within an ISP (Internet service provider) generate one 1 MB document each day that must be encrypted and signed, the processor must encrypt 100 GB of data. If encrypting one byte takes 200 cycles, and if the processor speed is 500 MHz, the processor would be encrypting and decrypting for about 11 hours each day. If these users are in the same geographical region and they use the server for 16 hours each day, then the machine spends 16 hours servicing the requests rather than just 5 hours per day. Thus, a server utilizing the CRCW device is able to provide greater than 3 times its original performance. Conversely, only one third of the hardware will be required to service the same demand.

Compilers

Compilers have the task of repetitively compiling often lengthy programs and are heavily used in software development environments. For every few lines of software written, the entire program is compiled and tested to determine whether these few lines have been coded correctly.

About 90% of the compiler time is spent in a parsing routine. Many tasks occur during parsing. However, precise data on how much time is spent in looking up symbols is not available. It is known that that each literal that is scanned must be identified as a keyword or a valid user symbol. Valid symbols are stored in the symbol table and a similar technique is used to access them. Thus, it can be concluded that symbol table lookup occupies a major portion of the parsing routine and if its execution speed is increased, considerable improvements can be obtained in the performance of the compiler.

The CRCW device may be used to improve the speed of symbol table lookups by a factor of 10 in a similar manner to that described above for databases. Each symbol may be stored in the device and a command may be given to ascertain whether a given symbol exists in the symbol table. If the symbol table lookup occupies about 50% of the parsing routine, the overall speed will be improved by a factor of about 2. Thus, the CRCW device ensures a competitive edge to compiler vendors while increasing the productivity of the end user or the software developer.

Word Processing Applications

Most conventional word processing applications have the ability to verify the spelling and perhaps grammar of words and phrases as they are being typed. Thus, for each word typed, a dictionary lookup is required. This places a significant load on the processor, which must perform many jobs in the background such as auto-saving and perhaps a compilation or Internet download. Since the dictionary contains a few hundred thousand words. One lookup implies a thousand machine cycles, which assumes that all words in the dictionary are present in main memory. Otherwise, page faults will occur and even more cycles are required.

The CRCW device performs this single operation about 100 times faster than a general-purpose microprocessor and stores the entire dictionary external to main memory, thereby saving valuable processor time and limited main memory resources. This results in fewer page faults and a significant improvement in the performance of word processing applications.

Translation Look-Aside Buffers

Virtual Memory (VM) implementation achieves the illusion of a nearly unlimited primary memory with the help of paging. If primary memory is 64 MB and secondary memory is 4 GB, a VM implementation makes it appear that the primary memory is 4 GB.

The processor generates an address and expects to access this address. It is the job of a memory management unit (MMU) to supply this information. If the accessed information is not in main memory, the MMU copies it from secondary memory so that it is.

The MMU has the job of tracking which portion of secondary memory is available in primary memory. Given that it somehow stores this information, it is faced with the task of answering whether the information at a particular address is available in primary memory. This question needs to be answered very quickly and is typically performed by a translation look-aside buffer (TLB).

The TLB stores all addresses that are currently available in primary memory and determines whether the input address is currently in primary memory. It answers this question by comparing each of its addresses to the input address in parallel.

Currently, secondary memory is in the order of terabytes and primary memory is in the order of gigabytes. If the page size were 16 KB, there would be 64 M different pages, and each page address would be 4 bytes long. Thus, a maximum of 64 K pages could reside in primary memory. This implies that the TLB should be 64 K·4 B=256 KB long, which may become prohibitively expensive to manufacture. However, the CRCW device could accomplish this task for a fraction of the cost since only 4 K of the memory requires the comparison logic shared by the complete 256 KB of memory.

Therefore, the method and apparatus formed in accordance with the present invention provide an integrated circuit for accelerating operations performed in floating point arithmetic processors, translation look-aside buffers, routers, switches, graphic processors, compilers, word processing algorithms, and Internet security algorithms while efficiently performing various database search algorithms on multi-dimensional arrays of memory in a cost-effective manner. The present invention also provides an integrated circuit having logic functions and storage capability that are peripheral to a microprocessor wherein the integrated circuit performs repetitive functions on multi-dimensional arrays of memory that are stored within the integrated circuit. The performance of existing microprocessor- or microcontroller-based systems may also be readily upgraded using the method and apparatus formed in accordance with the present invention.

Although illustrative embodiments of the present invention have been described herein with reference to the accompanying drawing, it is to be understood that the invention is not limited to those precise embodiments, and that various other changes and modifications may be effected therein by one skilled in the art without departing from the scope or spirit of the invention.

What is claimed is:

1. An integrated circuit that performs at least one search function, the integrated circuit comprising:
an interface circuit, the interface circuit being responsive to at least one device external to the integrated circuit;
a logic circuit, the logic circuit being responsive to the interface circuit, the logic circuit performing the at least one search function; and
a storage circuit, the storage circuit being responsive to the interface circuit, the interface circuit being adapted to provide an electrical interface between the logic circuit and the at least one device external to the integrated circuit, the interface circuit being adapted to provide an electrical interface between the storage circuit and the at least one device external to the integrated circuit, the storage circuit including table memory and operational plane memory, the operational plane memory being coupled to the table memory to enable each location in the operational plane memory to be simultaneously coupled in parallel to a unique location in the table memory, the storage circuit storing at least one table in the table memory, the storage circuit storing at least one table in the operational plane memory, the at least one search function being performed on the at least one table while the at least one table is stored in the operational plane memory.

2. An integrated circuit that performs at least one search function as defined by claim 1, wherein the integrated circuit is adapted for use as a peripheral device to at least one of a microprocessor, a microcontroller, and an application specific integrated circuit (ASIC).

3. An integrated circuit that performs at least one search function as defined by claim 1, wherein at least one of the table memory and the operational plane memory includes a multi-dimensional array of memory.

4. An integrated circuit that performs at least one search function as defined by claim 1, wherein at least one of the table memory and the operational plane memory includes at least one column, at least one row, and at least one table.

5. An integrated circuit that performs at least one search function as defined by claim 4, wherein the at least one column includes an array of bytes, the at least one row includes an array of columns, and the at least one table includes an array of rows.

6. An integrated circuit that performs at least one search function as defined by claim 1, wherein the interface circuit includes at least one register.

7. An integrated circuit that performs at least one search function as defined by claim 6, wherein the search function generates an output, the output being stored in the at least one register, the at least one device external to the integrated circuit reading the output of the search function from the at least one register.

8. An integrated circuit that performs at least one search function as defined by claim 6, wherein the at least one device external to the integrated circuit writes a command to the at least one register, the interface circuit interpreting the command and initiating an action in the integrated circuit in response to the command.

9. An integrated circuit that performs at least one search function as defined by claim 8, wherein the command is representative of at least one of specifying a portion of the storage circuit in which to store the at least one table, initiating storage of the at least one table in the storage circuit, specifying the at least one table stored in the storage circuit on which to perform the at least one search function, specifying at least one search key, specifying the at least one search function, and initiating the at least one search function.

10. An integrated circuit that performs at least one search function as defined by claim 1, wherein the at least one table includes a plurality of entries, the logic circuit including a plurality of processors, the plurality of processors performing the at least one search function in parallel on the plurality of entries.

11. An integrated circuit that performs at least one search function as defined by claim 1, wherein the at least one table includes a plurality of entries, the logic circuit outputting at least one of the plurality of entries that equals a search key.

12. An integrated circuit that performs at least one search function as defined by claim 1, wherein the at least one table includes a plurality of entries, the logic circuit outputting at least two of the plurality of entries between which a search key is located.

13. An integrated circuit that performs at least one search function as defined by claim 1, wherein the logic circuit performs at least one of a sequential and a parallel N-ary search.

14. An integrated circuit that performs at least one search function as defined by claim 1, wherein the table is modified while the table is in the operational plane memory.

15. A method of performing a search function in an integrated circuit, the method comprising the steps of:
storing a table into a table memory in the integrated circuit;
inputting a search key;
transferring substantially simultaneously the table in parallel from the table memory to an operational plane memory in the integrated circuit;
performing at least one search function on the table in the operational plane memory using the search key; and
outputting a result of the at least one search function.

16. A method of performing a search function in an integrated circuit, the method comprising the steps of:
storing a plurality of tables into a table memory in the integrated circuit;
inputting a table identifier, the table identifier being representative of one of the plurality of sorted tables;
inputting a search key;
transferring substantially simultaneously at least one of the plurality of tables represented by the table identifier in parallel from the table memory to an operational plane memory in the integrated circuit;
performing at least one search function on the at least one table in the operational plane memory using the search key; and
outputting a result of the at least one search function.

17. A method of performing a search function in an integrated circuit as defined by claim 16, the method further comprising the step of coupling the integrated circuit to at least one of a microprocessor, a microcontroller, and an application specific integrated circuit (ASIC).

18. A method of performing a search function in an integrated circuit as defined by claim 16, the method further comprising the step of arranging at least one of the table memory and the operational plane memory as a multi-dimensional array of memory.

19. A method of performing a search function in an integrated circuit as defined by claim 16, the method further comprising the step of arranging at least one of the table memory and the operational plane memory in at least one column, at least one row, and at least one table.

20. A method of performing a search function in an integrated circuit as defined by claim 16, the method further comprising the steps of:
arranging the at least one column as an array of bytes;
arranging the at least one row as an array of columns; and
arranging the at least one table as an array of rows.

21. A method of performing a search function in an integrated circuit as defined by claim 16, the method further comprising the step of storing the result in at least one register in the integrated circuit, the at least one register being accessible to at least one device external to the integrated circuit.

22. A method of performing a search function in an integrated circuit as defined by claim 16, the method further comprising the steps of:
inputting a command to at least one register in the integrated circuit;
interpreting the command by the integrated circuit; and
initiating an action in the integrated circuit in response to the command.

23. A method of performing a search function in an integrated circuit as defined by claim 22, wherein the command is representative of one of specifying a portion of the storage circuit in which to store at least one of the plurality of tables, initiating storage of the plurality of tables in the storage circuit, specifying the at least one table stored in the storage circuit on which to perform the at least one search function, specifying at least one search key, specifying the at least one search function, and initiating the at least one search function.

24. A method of performing a search function in an integrated circuit as defined in claim 16, the method further comprising the step of inputting a search function identifier, the search function identifier being representative of one of the plurality of search functions, the integrated circuit, performing the at least one search function represented by the search function identifier.

25. A method of performing a search function in an integrated circuit as defined in claim 16, wherein the at least one table includes a plurality of entries, the step of performing the at least one search function being performed in parallel on the plurality of entries of the at least one table.

26. A method of performing a search function in an integrated circuit as defined in claim 16, wherein the at least one table includes a plurality of entries, the result including at least one of the plurality of entries that equals a search key.

27. A method of performing a search function in an integrated circuit as defined in claim 16, wherein the at least one table includes a plurality of entries, the result including at least two of the plurality of entries between which a search key is located.

28. A method of performing a search function in an integrated circuit as defined in claim 16, wherein the at least one search function performed includes at least one of a sequential and a parallel N-ary search.

29. A method of performing a search function in an integrated circuit as defined in claim 16, wherein the step of transferring one of the plurality of tables substantially simultaneously in parallel from the table memory to the operational plane memory in the integrated circuit is performed in response to the integrated circuit receiving an initiate search command.

30. A method of performing a search function in an integrated circuit as defined in claim 16, the method further comprising the step of modifying the at least one table while the at least one table is in the operational plane memory.

31. A system that performs at least one search function, the system comprising:
at least one external device, the at least one external device being external to the integrated circuit; and
an integrated circuit, the integrated circuit including:
an interface circuit, the interface circuit being responsive to the at least one external device;
a logic circuit, the logic circuit being responsive to the interface circuit, the logic circuit performing the at least one search function; and
a storage circuit, the storage circuit being responsive to the interface circuit, the interface circuit being providing an electrical interface between the logic circuit and the at least one external device, the interface circuit providing an electrical interface between the storage circuit and the at least one external device, the storage circuit including table memory and operational plane memory, the operational plane memory being coupled to the table memory to enable each location in the operational plane memory to be simultaneously coupled in parallel to a unique location in the table memory, the storage circuit storing at least one table in the table memory, the storage circuit storing at least one table in the operational plane memory, the at least one search function being performed on the at least one table while the at least one table is stored in the operational plane memory.

32. An integrated circuit that performs at least one search function as defined by claim 31, wherein the integrated circuit is adapted for use as a peripheral device to the at least one external device, the at least one external device including at least one of a microprocessor, a microcontroller, and an application specific integrated circuit (ASIC).

33. An integrated circuit that performs at least one search function as defined by claim 31, wherein at least one of the table memory and the operational plane memory includes a multi-dimensional array of memory.

34. An integrated circuit that performs at least one search function as defined by claim 31, wherein at least one of the table memory and the operational plane memory includes at least one column, at least one row, and at least one table.

35. An integrated circuit that performs at least one search function as defined by claim 34, wherein the at least one column includes an array of bytes, the at least one row includes an array of columns, and the at least one table includes an array of rows.

36. An integrated circuit that performs at least one search function as defined by claim 31, wherein the interface circuit includes at least one register.

37. An integrated circuit that performs at least one search function as defined by claim 36, wherein the search function generates an output, the output being stored in the at least one register, the at least one device external to the integrated circuit reading the output of the search function from the at least one register.

38. An integrated circuit that performs at least one search function as defined by claim 36, wherein the at least one device external to the integrated circuit writes a command to the at least one register, the interface circuit interpreting the command and initiating an action in the integrated circuit in response to the command.

39. An integrated circuit that performs at least one search function as defined by claim 38, wherein the command is representative of at least one of specifying a portion of the storage circuit in which to store the at least one table, initiating storage of the at least one table in the storage circuit, specifying the at least one table stored in the storage circuit on which to perform the at least one search function, specifying at least one search key, specifying the at least one search function, and initiating the at least one search function.

40. An integrated circuit that performs at least one search function as defined by claim 31, wherein the at least one table includes a plurality of entries, the logic circuit including a plurality of processors, the plurality of processors performing the at least one search function in parallel on the plurality of entries.

41. An integrated circuit that performs at least one search function as defined by claim 31, wherein the at least one table includes a plurality of entries, the logic circuit outputting at least one of the plurality of entries that equals a search key.

42. An integrated circuit that performs at least one search function as defined by claim 31, wherein the at least one table includes a plurality of entries, the logic circuit outputting at least two of the plurality of entries between which a search key is located.

43. An integrated circuit that performs at least one search function as defined by claim 31, wherein the logic circuit performs at least one of a sequential and a parallel N-ary search.

44. An integrated circuit that performs at least one search function as defined by claim 31, wherein the table is modified while the table is in the operational plane memory.

45. A method of performing a search function, the method comprising the steps of:
inputting unsorted entries;
performing a hash function on the unsorted entries, the hash function arranging the unsorted entries into a sorted table;
storing the sorted table into a table memory in an integrated circuit;
inputting a search key;
transferring substantially simultaneously the sorted table in parallel from the table memory to an operational plane memory in the integrated circuit;
performing at least one search function on the sorted table in the operational plane memory using the search key; and
outputting a result of the at least one search function.

46. A method of performing a search function, the method comprising the steps of:
inputting unsorted entries;
performing a first hash function on the unsorted entries, the first hash function arranging the unsorted entries into a plurality of sorted tables;
storing the plurality of sorted tables into a table memory in an integrated circuit;
inputting a search key;
performing a second hash function on the search key, the second hash function outputting a table identifier, the table identifier being representative of one of the plurality of sorted tables in which the search key is likely to be found;
transferring substantially simultaneously at least one of the plurality of tables represented by the table identifier in parallel from the table memory to an operational plane memory in the integrated circuit;
performing at least one search function on the at least one table in the operational plane memory using the search key; and
outputting a result of the at least one search function.

47. A method of performing a search function as defined by claim 46, wherein the steps of performing a first hash function and performing a second hash function are performed by at least one of a microprocessor, a microcontroller, and an application specific integrated circuit (ASIC).

48. A method of performing a search function as defined by claim 46, the method further comprising the step of arranging at least one of the table memory and the operational plane memory as a multi-dimensional array of memory.

49. A method of performing a search function as defined by claim 46, the method further comprising the step of arranging at least one of the table memory and the operational plane memory in at least one column, at least one row, and at least one table.

50. A method of performing a search function as defined by claim 46, the method further comprising the steps of:
arranging the at least one column as an array of bytes;
arranging the at least one row as an array of columns; and
arranging the at least one table as an array of rows.

51. A method of performing a search function as defined by claim 46, the method further comprising the step of storing the result in at least one register in the integrated circuit, the at least one register being accessible to at least one device external to the integrated circuit.

52. A method of performing a search function as defined by claim 46, the method further comprising the steps of:
inputting a command to at least one register in the integrated circuit;
interpreting the command by the integrated circuit; and
initiating an action in the integrated circuit in response to the command.

53. A method of performing a search function as defined by claim 52, wherein the command is representative of one of specifying a portion of the storage circuit in which to store at least one of the plurality of tables, initiating storage of the plurality of tables in the storage circuit, specifying the at least one table stored in the storage circuit on which to perform the at least one search function, specifying at least one search key, specifying the at least one search function, and initiating the at least one search function.

54. A method of performing a search function as defined in claim 46, the method further comprising the step of inputting a search function identifier, the search function identifier being representative of one of the plurality of search functions, the integrated circuit performing the at least one search function represented by the search function identifier.

55. A method of performing a search function as defined in claim 46, wherein the at least one table includes a plurality of entries, the step of performing the at least one search function being performed in parallel on the plurality of entries of the at least one table.

56. A method of performing a search function as defined in claim 46, wherein the at least one table includes a plurality of entries, the result including at least one of the plurality of entries that equals a search key.

57. A method of performing a search function as defined in claim 46, wherein the at least one table includes a plurality of entries, the result including at least two of the plurality of entries between which a search key is located.

58. A method of performing a search function as defined in claim 46, wherein the at least one search function performed includes at least one of a sequential and a parallel N-ary search.

59. A method of performing a search function as defined in claim 46, wherein the step of transferring one of the plurality of tables substantially simultaneously in parallel from the table memory to the operational plane memory in the integrated circuit is performed in response to the integrated circuit receiving an initiate search command.

60. A method of performing a search function as defined in claim 46, the method further comprising the step of modifying the at least one table while the at least one table is in the operational plane memory.
